(19) United States
(12) Patent Application Publication
(10) Pub. No.: US 2014/0013211 A1
(43) Pub. Date: Jan. 9, 2014

(54) CONTENT PROVIDING APPARATUS COMPATIBLE WITH VARIOUS TERMINAL DEVICES

(71) Applicant: Kazutoshi Sakata, Tokyo (JP)

(72) Inventor: Kazutoshi Sakata, Tokyo (JP)

(73) Assignee: SYMMETRIC CO., LTD., Tokyo (JP)

(21) Appl. No.: 13/979,758

(22) PCT Filed: Apr. 11, 2012
(86) PCT No.: PCT/JP2012/059821

§ 371 Date: Jul. 15, 2013

(30) Foreign Application Priority Data
Apr. 15, 2011 (JP) 2011-091593

(51) Int. Cl. G06F 17/22

(52) U.S. Cl. CPC G06F 17/2247
USPC 715/235

(57) ABSTRACT

Problem: To display the contents written in mark-up languages in the screen format optimized for each of the various devices.

Solution: By dynamically generating and applying differences between the default style sheet and the style sheet optimized for a specific device based on the rewrite rules, eliminating the burden of managing multiple style sheets.

### TECHNICAL FIELD

The present invention relates to an apparatus, method and computer program that displays contents written in markup languages in the style optimized for each display device type.

### BACKGROUND ART

In the Internet today, it is common to display contents written in markup languages such as HTML and XHTML in the web browsers.

In the past, the types of content display devices, such as personal computers, were relatively limited. Today, in contrast, the display devices in the Internet is quite diversified.

In particular, portable phone devices have been driving diversity of display devices. Moreover, even in the category of portable phone devices, smart phones with larger displays are becoming popular, as well as traditional cellular phones with relatively small displays. Furthermore, tablet devices with even larger displays than those of smart phones are rapidly becoming popular. In addition to the above devices, it is predicted that devices connected to the Internet and displaying contents written in markup languages, such as portable game devices, car navigation systems and digital signage, will be rapidly diversifying.

Input methods for such devices are also diversifying. In addition to mice and keyboards in traditional personal computers, small buttons on the cellular phones and touch-based input methods, typically seen in smart phones and tablet devices, are becoming popular.

This diversification of the devices calls for various content display methods optimized for each device type. For display devices with a large screen, it is often desirable that one screen contains as many items as possible in order to avoid unnecessary page navigation. In contrast, for display devices with a smaller screen, it is often desirable that one screen contain only important items to improve readability. While users can easily handle smaller menu items on devices with a pointing device such as a mouse, it is often desirable to display larger menu items on devices with finger touch-based interface, because a user will have difficulty in interacting with small menu items with his fingers.

It is not reasonable; of course, that the contents providers create and set up multiple contents for each of these various device types. To solve this issue, style sheet technologies are now widespread. With style sheets, one can handle content and its structures separately from its display formats (i.e. appearance, style, design and layout). The style sheet files contain the formats for displaying contents, such as character size, color, and layout, separately from contents themselves and their structures. The content provider can adjust display of the contents to various display device type, with one common content file, by switching style sheet files as necessary. Such a style sheet technology is disclosed in, for example, U.S. Pat. No. 5,860,073.

In the Internet today, a style sheet technology standard called CSS (Cascading Style Sheet) is widespread. Here, the term “cascading” means priority rules in applying styles to contents. For example, in the CSS standard, the style specifications in the latter position generally overrides the ones in the former position. Using this cascading mechanism, the style can be changed by overriding the style of specific rules in a CSS file with another CSS file. For example, if the original CSS file is designed such that the colors represent the structure of the content (e.g. headers, paragraphs or links to other contents), on monochrome display devices its usability would be significantly sacrificed; using cascading mechanisms of CSS, one can prepare another CSS file such that the structure of the content is represented with character sizes and font styles (e.g. bold, italic or underline), overriding a part of the styles in the original CSS files, and optimizing the display on the devices with monochrome display. In this case, the content file does not have to be changed.

In the explanations below, the examples using CSS, a common technology standard in today's Internet, and HTML and XHTML, a standard format for authoring contents, are shown. The essence of the present invention, however, can be applied to any content display systems with a cascading mechanism. In this specification, “display” can mean any processes that make the contents sensible to human, such as display to the screen, print on the paper, and “text to speech”.

CSS technologies have contributed greatly to solving the issue of flexibly handling increasingly diversifying content display devices in the Internet. Only standard use of CSS technology, however, is not enough for content providers to optimize the display style for each of diversifying content display devices. Currently common methods of handling multiple CSS files and the issues thereof are shown in the following paragraphs.

(The problems in traditional methods)

The first method is to prepare a separate CSS file for each device type and switch between those multiple CSS files. In this method, the content provider has to explicitly specify links to the CSS files when creating XHTML (or HTML) content files. Considering that more than 800 device types are currently available in Japan, provided there are 5 links to CSS files in each content file, one would have to prepare and manage 4,000 (800 times 5) CSS files. Moreover, considering different CSS files may be used in each page of the one content, one would have to manage even more CSS files. As the number of the content display devices is growing and many web pages are being updated every day, it is becoming difficult to manage this extremely large number of CSS files.

The second method is to dynamically generate a CSS file for each device type. A common example of this type of method today is to use the XSL standard. With this standard, one has to create contents in XML. Since most devices except for standard personal computers lack the function of interpreting XML, there is a practical issue that all the devices cannot be supported with this method. In addition, there needs a mechanism to dynamically generate a complex XSL in order to handle the growing number of display devices, reducing the very benefit of CSS, namely, an easy change of the display format. Moreover, generally speaking, dynamically generating CSS files requires complex analysis of the structure of the contents, and this processing overhead to produce the correct styles, which must be done every time the structure of the content changes is huge. As a result, generating optimal CSS files is becoming difficult, considering the number of devices is growing and the web pages are being updated day after day. Generally speaking, since diversification of display devices is driven by the market dynamics, usefulness of this method, as depends on only a static standard such as XSL, is inherently limited.

The third method is to manipulate the CSS files with a script (commonly written in JavaScript Language (registered trademark) built in the browsers). This method has practical problems in that many devices lack JavaScript support; one has to manage as many scripts as the number of device types multiplied by the number of pages; CSS file manipulation by JavaScript language is hard to test for each device type; and JavaScript is a difficult language to code in purpose of HTML analysis.

The fourth method is to use the browser built-in functionality for switching CSS file to be applied for each device type. Even with this method, one still has to prepare the CSS files optimized to each device type, thus the one still has to create vast number of CSS files, which will result in similar problems as the first method. Many devices also do not support CSS switching function.

### SUMMARY OF THE INVENTION

### Problems To Be Solved By The Invention

To provide a content-providing apparatus and a computer program that solves the problems regarding management of CSS files in order to enable optimal display of the contents on various devices, limiting the number of objects to be managed in spite of the increasing number of the devices and the web pages, eliminating complex analysis processing of the contents (HTML or XHTML files), and not depending on the specific implementation of the browsers on the devices.

### MEANS FOR SOLVING THE PROBLEM

The present invention solves the above problems by providing a content-providing apparatus comprising: a content converting apparatus having a difference generation program, a first style-sheet storage, a second style-sheet storage, and a style-sheet translation-rule storage; wherein the difference generation program is configured to read a first style-sheet from the first-style sheet storage, read a translation-rule from the translation-rule storage, and extract more than one items that have matching keys with keys in the translation rule, replace the attribute values of each of the items with attributes in the translation rule, generate the second style-sheet, and save a second style-sheet in the second style-sheet storage; wherein the first style-sheet, the second-sheet and the translation-rule comprise key items and attributes.

The present invention also solves the above problems by providing a content-providing program comprising: a content converting apparatus having a difference generation program, a first style-sheet storage, a second style-sheet storage, and a style-sheet translation-rule storage; wherein the difference generation program is configured to read a first style-sheet from the first-style sheet storage, read a translation-rule from the translation-rule storage, and extract more than one items that have matching keys with keys in the translation rule, replace the attribute values of each of the items with attributes in the translation rule, generate the second style-sheet, and save a second style-sheet in the second style-sheet storage; wherein the first style-sheet, the second-sheet and the translation-rule comprise key items and attributes.

### ADVANTAGEOUS EFFECT OF THE INVENTION

With the present invention, it becomes possible to display the contents on devices in the format that fit their screen size and input method, reducing management burden of the content administrator, and minimizing processing overhead on the server for analyzing the content files.

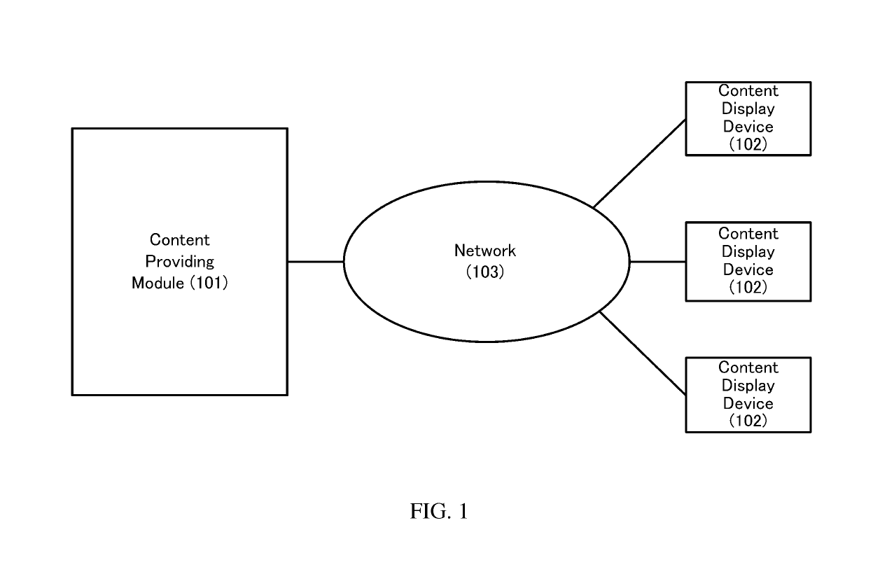

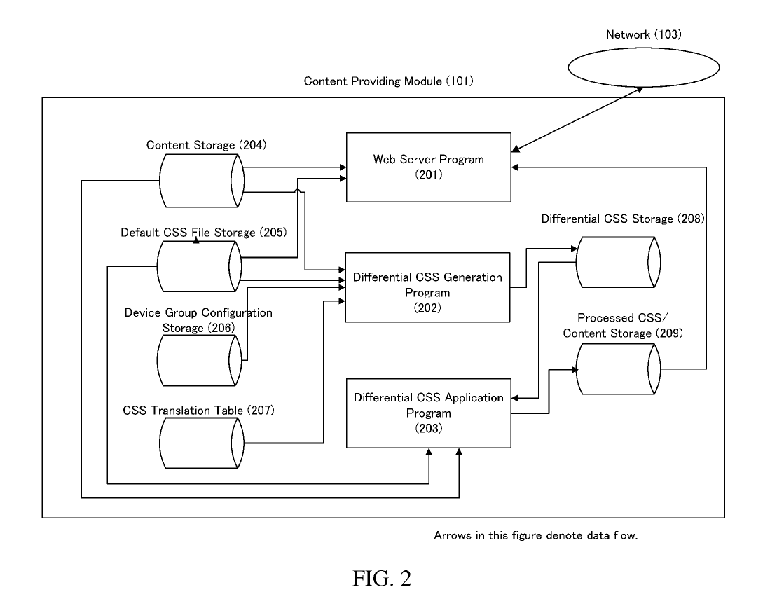

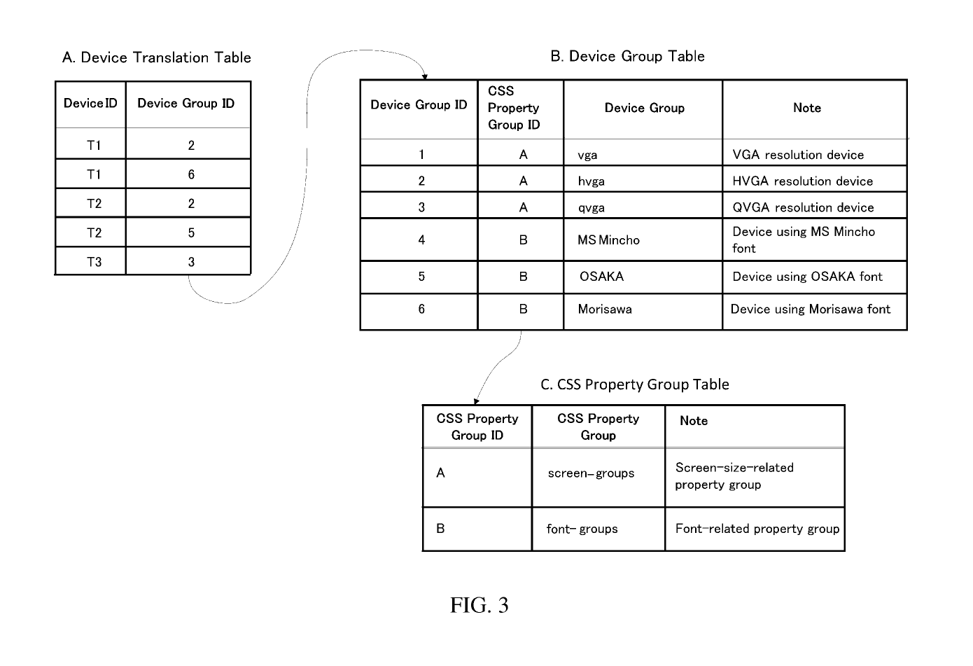

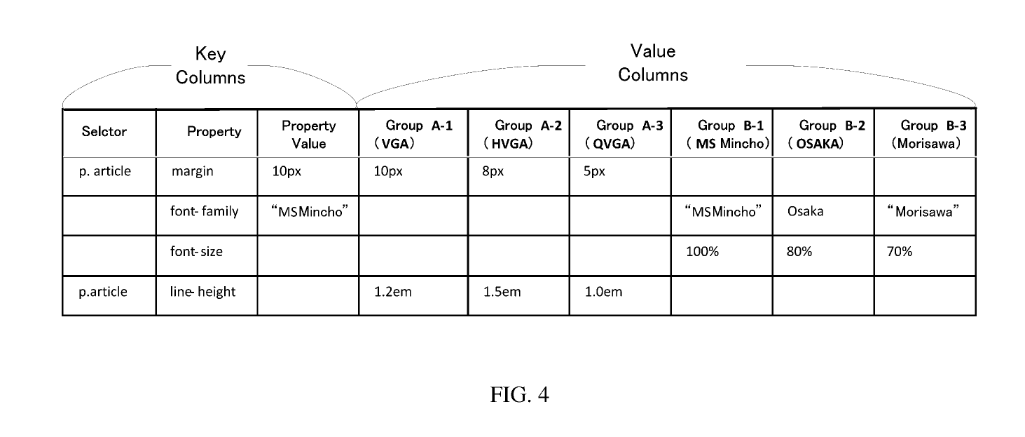

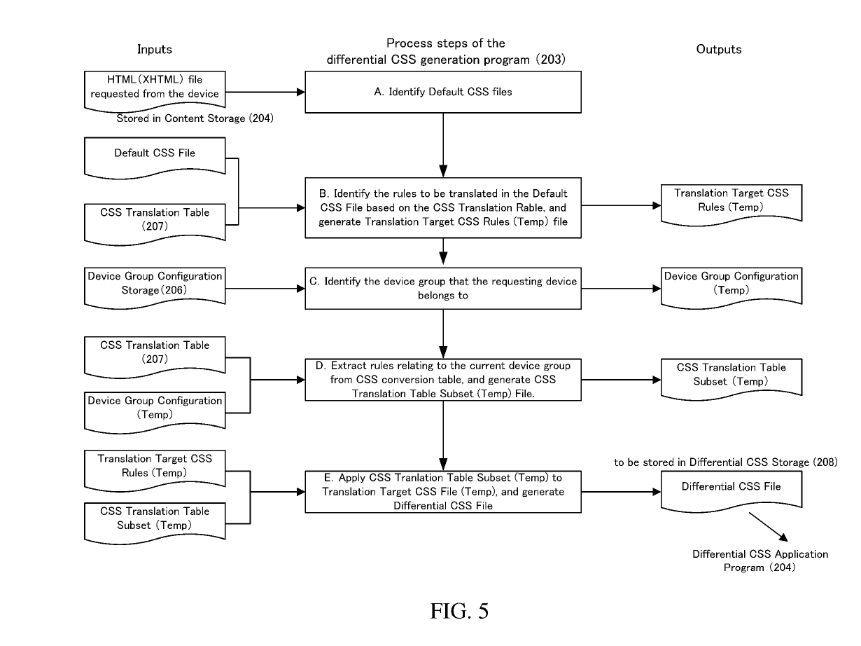

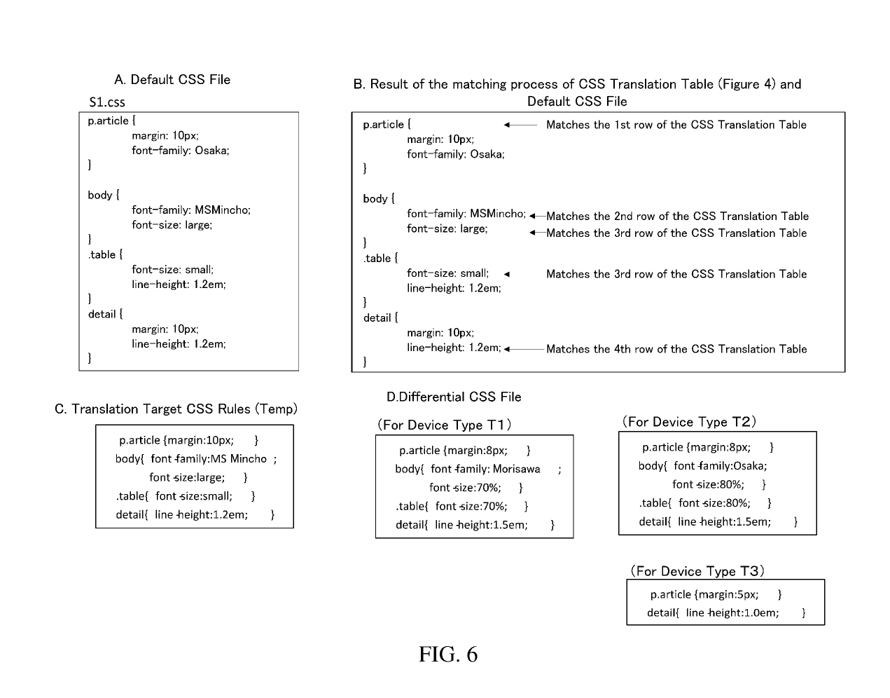

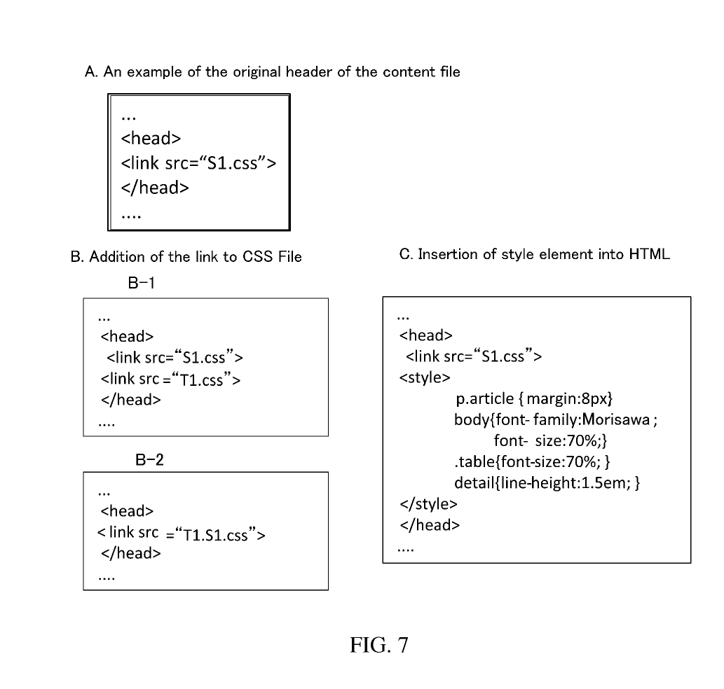

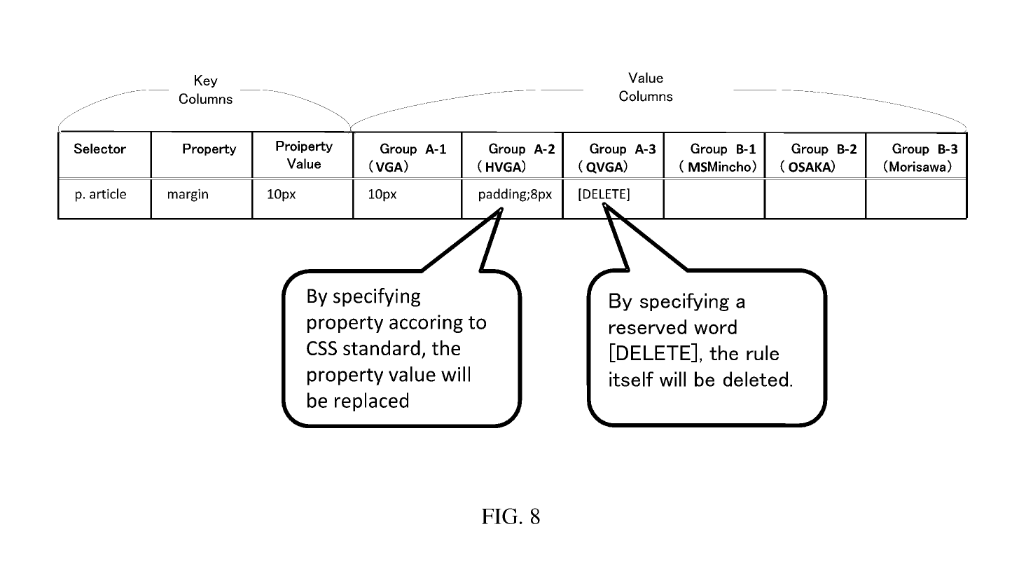

### BRIEF DESCRIPTION OF DRAWINGS

[FIG. 1] FIG. 1 is an overall information system configuration of an embodiment of the present invention.

[FIG. 2] FIG. 2 is an internal structure of a content providing module, a key component of an embodiment of the present invention.

[FIG. 3] FIG. 3 is an example of a device group configuration (a sub-component in FIG. 2) used in an embodiment of the present invention.

[FIG. 4] FIG. 4 is an example of a CSS translation table (a sub-component in FIG. 2) used in an embodiment of the present invention.

[FIG. 5] FIG. 5 is an example of process steps of a differential CSS generation program (a sub-component in FIG. 2) used in an embodiment of the present invention.

[FIG. 6] FIG. 6 is an example of the result of the differential CSS generation program shown in FIG. 5.

[FIG. 7] FIG. 7 is an example of the result of a differential CSS application program (a sub-component in FIG. 2) used in an embodiment of the present invention.

[FIG. 8] FIG. 8 is an example of specifying property deletion and modification in a differential CSS application program used in an embodiment of the present invention.

### DESCRIPTION OF EMBODIMENTS p An information system, a content display method, and computer programs executing the method, as embodiments of the present invention will be described in detail.

FIG. 1 is a one embodiment of an information system provided by the present invention. A content providing module (101) sends the contents created in, typically, HTML and XHTML to one or more content display devices (102), enabling the users to view the contents. It is typically implemented by a server hardware and programs running on that server hardware, but is not limited to thereof. The internal components of the content providing module are explained later.

A content display device (102) is a hardware device that can display contents. It is typically a hardware device with a mean (typically, a web browser) for displaying contents, specifically (but not limited to), a personal computer, a portable phone, a tablet device, a game console, a car navigation system and a digital signage.

The network is a mean to interconnect the content providing module (101) and one or more content display devices (102). It is typically the Internet, but is not limited to thereof.

The components other than the content providing module (101) are common in today's Internet, so will not be further explained in detail. In the following paragraphs, the internal structure and the process steps of the content providing module (101) will be explained.

FIG. 2 is an internal structure of the content providing module (101). Its main components are a web server program (201), a differential CSS generation program (202) and a differential CSS application program (203).

The web server program (201) sends the contents to the content display devices (102), using common internet protocols such as HTTP, HTML, XHTML and CSS. Since the web server program (201) is a widespread technology in today's Internet, its internal functions and processes will not be explained further.

The differential CSS generation program (202) reads the default CSS file created by the system administrator, and generates a differential CSS file, based on the information in a device group configuration storage (206) and a CSS translation table (207), which are created by the content creator or the content administrator. The detailed internal process steps of the differential CSS generation program (202) will be explained later.

The differential CSS application program (203) overrides a part of the styles specified in the default CSS file, enabling the web server program (201) to send the contents to the display devices in the styles optimized for each device type. The detailed processes of the differential CSS application program (203) will be explained later.

A content storage (204) is a file, database and the like that stores the contents (typically, web pages written in HTML or XHTML) that the web server program (201) sends to the content display devices (102). Since the content storage (204) is a widespread technology in today's Internet, it will not be explained further.

A default CSS file storage (205) is a file, database and the like that stores the basic CSS files that the content creator or the content administrator creates. Preferably, these CSS specifications may be written according to a common CSS standard. In general web server systems, the default CSS file storage (205) is an essential and widespread technology, so it will not be explained further.

The device group configuration storage (206) is a database or file created by the content creators or the content administrators. Its purpose is to manage multiple device types with common characteristics as groups. FIG. 3 shows an example of device group specifications in the device group configuration storage (206). Device ID (identifier) represents each specific device (typically, a model number). Device translation table (FIG. 3A) associates a specific device ID with one or more device groups. A device group table (FIG. 3B) associates each device group (a group of devices with common characteristics) to one device group. CSS property group is the characteristics of the device group categories. For example, multiple device types with the same screen size usually are categorized into the same device group by the content administrator. One device type can belong to multiple device groups. In the example of FIG. 3, the device T1 belongs to VGA (in terms of the screen size) device group and “MORISAWA” (in terms of the font) device group. The device group configuration is used to define the rules with which the differential CSS generation program (201) replaces the property values in the CSS file.

The CSS translation table (207) is a table created by the content creators or the content administrators. It is used to specify the rules with which the differential CSS generation program (202) extracts and modifies the differential CSS file which is to be applied to the default CSS file. Typically, the CSS translation table (207) is implemented with files or databases on the server hardware. FIG. 4 shows an example of the CSS translation table (207). Here, selector designates the elements (headers or paragraphs, for example) that the format (style) is applied to. Property is a specific characteristic of the format (style). Property value is a specific value of that property. Here “selector” and “property” are standard terms defined in the CSS standard, thus in an embodiment of the present invention, it is preferable to specify them in compliance with the standards. The selector column, the property column and the property value column comprise the key columns of the CSS translation table (207). The columns in the CSS translation table (207) other than those key columns are value columns, which contain the replacing value used by the differential CSS generation program (202) for each device group. For example, the first row of the CSS translation table (207) in FIG. 4 means that, for the devices in the device group A-2, the property value of the rules with matching key columns in the default CSS file is to be replaced to 8 px.

The device group configuration storage (206) and the CSS translation table (207) do not have to be physically the same file or database. Arbitrary physical implementations may be used, as far as they provide the logical functions disclosed in this specification, namely, using the device ID as a key, to identify the rules to be replaced and the replacing value. For example, it can be a file or a database.

In the following paragraphs, the process steps of differential CSS generation program (203), one of the technical features of the present invention is explained in detail.

FIG. 5 shows overview of the process steps and input/output files thereof of the differential CSS generation program (203). Temporary files, which exist only during the program execution and are deleted by the system or the differential CSS generation program (203), are not shown in FIG. 5.

(Step A in FIG. 5) A content display device (102) sends a request (typically with HTTP GET/POST request) for a specific content to the web server program (201) in the content providing module (101). The web server program (201) passes that request to the differential CSS generation program (203). The differential CSS generation program (203) identify the default CSS files used in the content file that the content display device (102) has requested. Typically, the differential CSS generation program can identify the default CSS files by searching “link” tag in the content file written in HTML in compliance with the Internet standard specifications.

(Step B in FIG. 5) The differential CSS generation program (203) looks up the CSS translation table (207) and sequentially checks each rule in the default CSS file that was identified in the processes described in Step A in FIG. 5 to see if there are any matches of the key columns of the CSS translation table (207). Here, “match” can be in either 1) a combination of a selector, a property name, and a property value; 2) a combination of a property name, and a property value; 3) a combination of a selector and a property name; or 4) a property name. Preferably, the matching priority may be that a former combination listed here has a higher priority. That is, for example, a rule that matches all of the selector, the property name, and the property value will be the target of property value replacement even if there are other rules that matches the combination of only a selector and a property name. The differential CSS generation program (203) extracts the rules that matches the keys specified in the CSS translation table (207) from the rules in the default CSS file, and creates a temporary translation target CSS rules file.

(Step C in FIG. 5) The request that the content display device (102) sent to the web server program (201) contains the identifier of the device type, such as the name of the browser and the model number of the portable phone. The differential CSS generation program (203) receives that device type identifier from the web server program (201) and, using it as a key, reads one or more device group id's, the names of the device group corresponding to each device group id, and CSS property group id's from the device group storage (206), and writes them to a temporary device group configuration file.

(Step D in FIG. 5) The differential CSS generation program (203) merges the temporary device group configuration file created in the process in Step C in FIG. 5 and the CSS translation table (207), and generates a temporary CSS translation table subset file. This temporary CSS translation table subset file contains only the rules extracted from the CSS translation table (207) that relate to the display device to which the content is to be sent.

(Step E in FIG. 5) The differential CSS generation program (203) applies the translation rules defined in the temporary CSS translation table subset to each rule in the translation target CSS rules created in the step B of FIG. 5. Specifically, for each rule among the translation target CSS rules with key columns matching those of the temporary subset CSS translation table, the property value in the translation target CSS rules will be replaced with the corresponding new property value in the temporary subset CSS translation table. Here, “the corresponding new property value” means the property value stored in the value column in the CSS translation table that corresponds to combination of the CSS property group and the device group the display device belongs to. It can be known which device group a certain device belongs to, and which device group and device group in the CSS Property Group, by referencing the device group configuration file (FIG. 3). After the differential CSS generation program (203) finishes all the translation process steps, it saves the resulting differential CSS file in the differential CSS storage (208). The differential CSS file saved by the CSS generation program (203) will be read by the differential CSS application program (204), which will perform the process steps explained later.

In the following paragraphs, the process steps of the differential CSS generation program (203) is explained again with sample data. Although this example is based on the W3C CSS standard specification, the present invention can be broadly applied to any content distribution systems using arbitrary style sheet technologies that are similar to CSS.

In this sample, the device group configuration in FIG. 3 and the CSS translation table in FIG. 4 will be used. FIG. 6A is an example default CSS file to be used in the following explanation.

(An example of the result of Step A and B in FIG. 5)

The differential CSS generation program (203) identifies the rules that match the key columns of the CSS translation table (shown in FIG. 4) by reading the default CSS file (FIG. 6A) from the beginning. In the CSS translation table (FIG. 4), the first line is a selector (p.article) that matches the rules whose property (margin) has property value of 10 px (where, “match” means that particular rule will be replaced). In this case, searching in the default CSS file involves a simple string match of “selectors” and an additional string match of “property value”. Since the second row of the CSS translation table (FIG. 4) does not have “selector” specification, the rules in the default CSS file that have the same property (font-size) and property value (“MS Mincho”) will match, with selector specification neglected. Since the third row of the CSS translation table (FIG. 4) also does not have “selector” specification, the rules in the default CSS file that have property of “font-size” will match. In this case, since there is no property value specification, every rule with property of “font-size” will match. In the fourth row of the CSS translation table in FIG. 4, the rules with “property” line-height within the specified selector (p.article) (all the rules with property “line-height” will match, since there is no property value specification). All the above matching process steps are shown in FIG. 6B. The differential CSS generation program (203) writes all the matching lines to a temporary translation target CSS rules file. This temporary file with this sample data is shown in FIG. 6C.

(An example of the result of Step C, D, and E in FIG. 5)

Depending of the device type requesting the content, the differential CSS generation program (203) uses the CSS translation table (FIG. 4) to replace the property values in the translation target CSS rules file. The results of process steps for three device types, T1, T2, and T3 are shown. In this example, as shown in the device group configuration (FIG. 3), in the terms of “screen size” (CSS Property Group ID of A), T1 and T2 belong to the device group 2, and T3 belongs to device group 3; and in terms of “font” (CSS Property Group ID of B), T1 belongs to the device group 3, and T2 belongs to the device group 3. T3 does not belong to any device group in terms of “font” CSS property group, meaning that the differential CSS generation program (203) will not translate the font specification for T3. Here, in the Property Group with CSS Property Group ID of A, for the device types that belong to the device group 1, property value in the column A-1 in the CSS translation table (FIG. 4) will be used for replacement. Other CSS Property Group IDs and the device groups will be processed similarly. The differential CSS file generated by the differential CSS generation program (203) for each device type in this example is shown in FIG. 6D.

All of the above process steps consist of simple string matching, do not need complex syntax analysis; thus require less hardware resource and are easy for the developers to implement apparatuses and programs as an embodiment of the present invention.

Now, the process steps of the differential CSS application program (204) are explained. The methods whereby the differential CSS application program (204) applies the differential CSS generated by the differential CSS generation program (203) are largely categorized into three groups. In the following paragraphs, examples of each method will be shown. In each example, it is assumed that the header of the default CSS file are as shown in FIG. 7A (this means that, before the translation processes, the display of the contents would be based on the styles deigned in the default CSS file in FIG. 6A).

The first method is to add links to CSS files to the HTML file. For example, if the differential CSS generation program generates the T1.css for the device type T1, the differential CSS application program (204) changes the content file so that it looks like FIG. 7B1. Naming of the differential CSS file is up to choice of the developer as a design option (for example, by adding URL or time stamps, unique files names such as www.foobar.jp.20110412134567.T1.css can be generated). Since, in the CSS standards, the latter style specifications override the former ones, content display in the formats compatible with various devices, an objective of the present invention is realized. Here, all the modification to the style are consolidated into one differential CSS file, the process overhead for multi-stage cascading on the device is eliminated.

As a variation of this first method, the differential CSS application program (204) may merge the default CSS file and the differential CSS file into a new CSS file, changing the content file so that it links to the newly created CSS file. FIG. 7B2 is an example of the header of the content file changed by the differential CSS application program (204) with this method. The above merge process is simple, and is easier to implement and involves less overhead than traditional methods of dynamically generating all of the CSS files.

The second method is that the differential CSS application program (204) inserts a “style” element of the CSS standards into the header of the HTML file.

FIG. 7c is an example of the header changed by the differential CSS application program (204) with this method. With CSS standards, style specification with a “style” element overrides specification in the linked external files, the optimum display to the device, an objective of the present invention, is realized.

With the second method, it is further for the differential CSS application program to change or delete the property. FIG. 8 is an example of specifying this type of processes. 801 is an example to change property value by specifying both the property and its value. 802 is an example to delete property altogether by specifying DELETE, a reserved word. Other reserved words may be used as arbitrary design options. With this type of design, it is possible to adjust the style in such a way that is not achievable with overriding effect of CSS cascading only.

The third method is that the differential CSS application program (204) identifies the tags in the HTML file that correspond to the selector in the differential CSS file, and insert “style” element to each of such tags.

With any of the above methods, the style setting effect of the differential CSS file overrides the default CSS file, and the style effect of the differential CSS file is applied, overriding that of the default CSS file. This enables standard web server programs (201) to display contents optimized to each of various device types, realizing an objective of the present invention. Since CSS file interpretation process of the web server program (201) is well-known, it will not be explained here.

(Definition of the terminology)

In the following paragraphs, the terms specific to this specification are summarized.

“Default CSS file” is the most generic CSS file created by the content creator. “Differential CSS file” is a CSS file that is equivalent to difference of the default CSS file and the CSS files optimized to the content displaying device. “Differential CSS generation program”(or “Difference generation program”) is a program that generate the differential CSS File, according to the information in the CSS translation table created by the content creator. “Differential CSS application program” is a program that makes style specification of the differential CSS file effective in the display of the contents, by way of, for example, merging the differential CSS file generated by the differential CSS generation program, in order to attain an objective of the present invention, that is, to enable the Web server program to provide the contents optimized for each device type. “Device group configuration storage” is a data storage that manages multiple device types with common characteristics as groups. It is created by the content creator or the content administrator. “CSS translation table” is a table created by the content creator or the content administrator, being saved as a database or a file. It is used to describe the rules that specify extraction and translation of the default CSS file into the differential CSS files (keys and new property values for each device group).

The device group configuration storage and the CSS translation table may be physically one file or database. In the claims, the CSS translation table and translation table as a whole are called style sheet translation rule. Key columns refer to selector, property, property value or combinations thereof. An attribute value is the synonym of a property value.

(Technical advantages of the present invention)

The advantages of the present invention compared to the traditional technologies are as the following. Firstly, since the translation process is done on the server hardware, not on the user device, the present invention can be applied to any user device with basic browser functionality. Secondly, since only the rules necessary for the translation process is specified in the CSS translation table, the burden of the administrator is smaller (the administrator does not have to manage a large number of CSS files.) Thirdly, since the display devices does not have to process multi-stage cascading with CSS, and only has to render at most one differential CSS file, performance degradation is minimal. Some portable devices have a difficulty in processing multi-stage cascading, but it is not an issue with the present invention. Fourthly, since there is no need for complex analysis of the contents files (written in HTML and/or XHTML), server performance in translating style sheets is higher, and system overhead and management burden can be minimized when translating content files. Fifthly, a default CSS file and a CSS translation table can be managed together, and the number of objects to be managed does not increase in proportion to the number of the contents, as opposed to the case of XHTML and XSL. Sixthly, even when the number of the target devices increases, one can handle the case by registering only additional devices to the device configuration table; the number of objects to be managed does not grow, and the contents do not have to be changed. Seventhly, even when one cannot use a fully functional system of an embodiment of the present invention (for example, when one is creating the contents on a personal computer without an internet connection), one can easily author content files with styles based on a default CSS. Finally, since specification of the translation table is compliant to the standard syntax of CSS, it is easy for the administrator to understand and for developers to code programs that utilize an embodiment of the present invention.

1-2. (canceled)

3. A method for converting display styles of contents, using a computer, comprising:
identifying a first style sheet used in a content file requested by a display device;
identifying a type of the display device;
extracting rules in the first style sheet that match one or more key columns in a translation table into a second style sheet; and
converting, using new values in value columns in the translation table, the rules in the second style sheet that are related to the type of the display device into a third style sheet that is equivalent to difference between the first style sheet and a desired style on the display device.

4. The method of claim 3, wherein the first style sheet, the second style sheet and the third style sheet are written in Cascading Style Sheet syntax.

5. The method of claim 4, wherein the key columns of the translation table are a selector, a property, and a property value.

6. The method of claim 5, wherein the value columns of the translation table are organized by device groups and property groups.

7. The method of claim 6, further comprising:
inserting a link element into the content file dynamically to specify the third style sheet.

8. The method of claim 7, wherein the third style-sheet file name is made unique by adding a time stamp value.

9. A non-transitory computer-readable storage medium having recorded a computer program for converting display styles of contents, causing a computer to execute:
identifying a first style sheet used in a content file requested by a display device;
identifying a type of the display device;
extracting rules in the first style sheet that match one or more key columns in a translation table into a second style sheet; and
converting, using new values in value columns in the translation table, the rules in the second style sheet that are related to the type of the display device requesting the content file into a third style sheet that is equivalent to difference between the first style sheet and a desired style on the display device.

10. A non-transitory computer-readable storage medium of claim 9, wherein the first style sheet, the second style sheet and the third style sheet are written in Cascading Style Sheet syntax.

11. A non-transitory computer-readable storage medium of claim 10, wherein the key columns of the translation table are a selector, a property, and a property value.

12. A non-transitory computer-readable storage medium of claim 11, wherein the value columns of the translation table are organized by device groups and property groups.

13. A non-transitory computer-readable storage medium of claim 12 further causing a computer to execute:
inserting a link element into the content file dynamically to specify the third style sheet.

14. A non-transitory computer-readable storage medium of claim 13, wherein the third style sheet file name is made unique by adding a time stamp value.

15. A server apparatus for converting display styles of contents comprising:
a unit configured to identify a first style sheet used in a content file requested by a display device;
a unit configured to identify a type of the display device;
a unit configured to extract rules in the first style sheet that match one or more key columns in a translation table; and
a unit configured to convert, using values in value columns in the translation table, the rules in the second style sheet that are related to the type of the display device into a third style sheet that is equivalent to difference between the first style sheet and a desired style on the display device.

16. The apparatus of claim 15, wherein the first style sheet, the second style and the third style sheet are written in Cascading Style Sheet syntax.

17. The apparatus of claim 16, wherein the key columns of the translation table are a selector, a property, and a property value.

18. The apparatus of claim 17, wherein the value columns of the translation table are organized by device groups and property groups.

19. The apparatus of claim 18, further comprising:
a unit configured to dynamically insert a link element into the content file to specify the third style sheet.

20. The apparatus of claim 19, wherein the third style sheet file name is made unique by adding a time stamp value.
